(19) United States
(12) Patent Application Publication
(10) Pub. No.: US 2026/0104069 A1
(43) Pub. Date: Apr. 16, 2026

(54) NON-UNIFORM STROKE DURATION APPARATUS AND ENGINE PROVIDED WITH THE SAME

(71) Applicants: Hyundai Motor Company, Seoul (KR); Kia Corporation, Seoul (KR)

(72) Inventors: Jinyoung JUNG, Hwaseong-Si (KR); Kiyoung KWON, Hwaseong-Si (KR); Sangyeon HAN, Hwaseong-Si (KR); Young Nam KIM, Hwaseong-Si (KR); You Sang SON, Hwaseong-Si (KR); Back Sik KIM, Hwaseong-Si (KR); Sangjae PARK, Hwaseong-Si (KR)

(73) Assignees: Hyundai Motor Company, Seoul (KR); Kia Corporation, Seoul (KR)

(21) Appl. No.: 19/348,499

(22) Filed: Oct. 2, 2025

(30) Foreign Application Priority Data
Oct. 14, 2024 (KR) 10-2024-0139772
May 9, 2025 (KR) 10-2025-0060636

(51) Int. Cl. F16C 3/10

(52) U.S. Cl. CPC F16C 3/10

(57) ABSTRACT

A non-uniform stroke duration apparatus includes a crankshaft including a first main crankshaft and a second main crankshaft coaxially disposed with the first main crankshaft and constantly rotating at the same speed as the first main crankshaft, and having a predetermined crankshaft rotation center, a plurality of pin journal units disposed between the first main crankshaft and the second main crankshaft, and an eccentric rotation transmitter including an internal bracket that rotates around an eccentric axis formed by a pivot angle in a predetermined direction and spaced apart from the crankshaft rotation center by a predetermined eccentric distance, and changing a relative rotation speed of the pin journal units with respect to the crankshaft.

### CROSS-REFERENCE TO RELATED APPLICATION

The present application claims priority to and the benefit of Korean Patent Application No. 10-2025-0060636 filed with the Korean Intellectual Property Office on May 9, 2025, and Korean Patent Application No. 10-2024-0139772 filed with the Korean Intellectual Property Office on Oct. 14, 2024, the entire contents of which are incorporated herein by reference.

### BACKGROUND OF THE PRESENT DISCLOSURE

### Field of the Present Disclosure

The present disclosure relates to a non-uniform stroke duration apparatus and an engine provided with the same, and more particularly, the present disclosure relates to a non-uniform stroke duration apparatus and an engine provided with the same capable of improving fuel efficiency of an engine.

### DESCRIPTION OF RELATED ART

A typical four-stroke engine operates through the strokes of intake, compression, expansion, and exhaust.

In a typical engine, the rotation speed (rpm) during each stroke remains almost constant.

With a time reference, the absolute combustion speed increases with engine rpm, but since the piston speed also increases, the relative combustion speed with a crank angle reference does not change much.

The information contained in this Background section is directed to promote understanding of the background of the present disclosure and may include matters that are not related art already known to a person of ordinary skill in the field to which the present technology belongs.

### BRIEF SUMMARY

The present disclosure attempts to provide a non-uniform stroke duration apparatus configured for improving the fuel efficiency of an engine by varying the relative speed of the piston in each stroke.

A non-uniform stroke duration apparatus according to various aspects of the present disclosure may include a crankshaft including a first main crankshaft and a second main crankshaft coaxially disposed with the first main crankshaft and constantly rotating at the same speed as the first main crankshaft, and having a predetermined crankshaft rotation center, a plurality of pin journal units disposed between the first main crankshaft and the second main crankshaft, and an eccentric rotation transmitter including an internal bracket that rotates around an eccentric axis formed by a pivot angle in a predetermined direction and spaced apart from the crankshaft rotation center by a predetermined eccentric distance, and changing a relative rotation speed of the pin journal units with respect to the crankshaft.

The eccentric rotation transmitter may include a power transmitter that transmits torque between the crankshaft and the internal bracket, and an external bracket on which the internal bracket is rotatably disposed.

The power transmitter may include a crankshaft pin that is movably inserted in the crankshaft in a direction perpendicular to a longitudinal direction of the crankshaft, a crankshaft pin head that is connected to the crankshaft pin and rotatably disposed on the internal bracket, and a rotation transmitting pin that is disposed between the internal bracket and the pin journal unit to transmit rotation.

The power transmitter may further include a rotation transmitting pin head which is rotatably inserted into the internal bracket and into which the rotation transmitting pin is inserted.

The power transmitter may includer a journal shaft pin movably inserted in a direction perpendicular to a longitudinal direction of an axis of the pin journal units, a journal shaft pin head connected to the journal shaft pin and rotatably disposed on the internal bracket, and a rotation transmitting pin disposed between the internal bracket and the pin journal unit to transmit rotation.

The power transmitter may further include a rotation transmitting pin head which is rotatably inserted into the internal bracket and into which the rotation transmitting pin is inserted.

An engine according to various aspects of the present disclosure may include a crankshaft including a first main crankshaft and a second main crankshaft coaxially disposed with the first main crankshaft and constantly rotating at the same speed as the first main crankshaft and having a predetermined crankshaft rotation center, a first pin journal portion including a first crank pin and a large diameter portion protruding in the crankshaft 10 direction, a second pin journal portion including a second crank pin, a third crank pin and first and second journal shafts protruding in both directions in the crankshaft direction, a third pin journal portion including a fourth crank pin and a large diameter portion protruding in a crankshaft direction, a first eccentric unit disposed between the first main crankshaft and the first pin journal portion, including a first internal bracket that rotates around a first eccentric axis formed by a pivot angle in a predetermined first direction and is spaced apart from the crankshaft rotation center by a predetermined first eccentric distance, and changing a relative rotation speed of the first pin journal portion with respect to the crankshaft, a second eccentric unit disposed between the first pin journal portion and the second pin journal portion, including a second internal bracket that rotates around a second eccentric axis formed by a pivot angle in a predetermined second direction and is spaced apart from the crankshaft rotation center by a predetermined second eccentric distance, and changing a relative rotation speed of the second pin journal portion with respect to the first pin journal portion, a third eccentric unit disposed between the second pin journal portion and the third pin journal portion, including a third internal bracket that rotates around a third eccentric axis formed by a pivot angle in the predetermined first direction and is spaced apart from the crankshaft rotation center by the predetermined second eccentric distance, and changing a relative rotation speed of the third pin journal portion with respect to the second pin journal portion, and a fourth eccentric unit disposed between the third pin journal portion and the second main crankshaft, including a third internal bracket that rotates around a fourth eccentric axis formed by a pivot angle in the predetermined second direction and is spaced apart from the crankshaft rotation center by the predetermined first eccentric distance, and changing a relative rotation speed of the second main crankshaft with respect to the third pin journal portion.

The first eccentric unit may include a first power transmitter for transmitting torque between the crankshaft and the first internal bracket, and a first external bracket on which the first internal bracket is rotatably disposed, and the fourth eccentric unit may include a fourth power transmitter for transmitting torque between the crankshaft and the fourth internal bracket, and a fourth external bracket on which the fourth internal bracket is rotatably disposed.

The first power transmitter may include a crankshaft pin movably inserted in a direction perpendicular to a longitudinal direction of the crankshaft, a crankshaft pin head connected to the crankshaft pin and rotatably disposed on the first internal bracket 42, and a rotation transmitting pin disposed between the first internal bracket and the first pin journal portion to transmit rotation, and the fourth power transmitter may include a crankshaft pin movably inserted in a direction perpendicular to a longitudinal direction of the crankshaft, a crankshaft pin head connected to the crankshaft pin and rotatably disposed on the fourth internal bracket, and a rotation transmitting pin disposed between the fourth internal bracket and the third pin journal portion to transmit rotation.

The first and fourth power transmitters may further include a rotation transmitting pin head, which is rotatably inserted into the first and fourth internal brackets and into which the rotation transmitting pin is inserted, respectively.

The second eccentric unit may include a second power transmitter for transmitting torque between the first journal shaft and the second internal bracket, and a second external bracket on which the second internal bracket is rotatably disposed, and the third eccentric unit may include a third power transmitter for transmitting torque between the second journal shaft and the third internal bracket, and a third external bracket on which the third internal bracket is rotatably disposed.

The second power transmitter may include a journal shaft pin that is movably inserted in a direction perpendicular to a longitudinal direction of the first journal shaft, a journal shaft pin head connected to the journal shaft pin and rotatably disposed on the second internal bracket, and a rotation transmitting pin that is disposed between the second internal bracket and the second pin journal portion to transmit rotation, and the third power transmitter may include a journal shaft pin that is movably inserted in a direction perpendicular to a longitudinal direction of the second journal shaft, a journal shaft pin head connected to the journal shaft pin and rotatably disposed on the third internal bracket, and a rotation transmitting pin that is disposed between the third internal bracket and the second pin journal portion to transmit rotation.

The second and third power transmitters may further include a rotation transmitting pin head, into which the rotation transmitting pin is inserted, rotatably inserted into the second and third internal brackets respectively.

The second eccentric distance may be twice the first eccentric distance, and the first direction and the second direction may be set symmetrically around the crankshaft.

The first direction and the second direction may be predetermined to slow down a relative speed of the piston to the crankshaft during the expansion stroke of each cylinder.

According to a non-uniform stroke duration apparatus according to an exemplary embodiment of the present disclosure, the fuel efficiency of the engine can be improved by varying the relative speed of the piston in each stroke.

Furthermore, any effects that can be obtained or expected due to an exemplary embodiment are directly or implicitly disclosed in the detailed description of an exemplary embodiment of the present disclosure. That is, various effects predicted according to an exemplary embodiment will be disclosed in the detailed description that follows.

### BRIEF DESCRIPTION OF THE DRAWINGS

These drawings are intended for reference in explaining exemplary embodiments of the present disclosure, and therefore, the technical ideas of the present disclosure should not be construed as being limited to the accompanying drawings.

FIG. 1 is a cross-sectional view of a non-uniform stroke duration apparatus by an exemplary embodiment of the present disclosure.

FIG. 2 is an exploded sectional view of a non-uniform stroke duration apparatus according to an exemplary embodiment of the present disclosure.

FIG. 3 is a cross-sectional view along line III-III of FIG. 1.

FIG. 4 is a cross-sectional view along line VI-VI of FIG. 1.

FIG. 5 is a drawing showing a rotation center of a crankshaft and an internal bracket of a non-uniform stroke duration apparatus according to an exemplary embodiment of the present disclosure.

FIG. 6 and FIG. 7 are graphs showing the operation principle of a non-uniform stroke duration apparatus according to an exemplary embodiment of the present disclosure.

FIG. 8 is a graph illustrating the eccentricity and pivot angle of a non-uniform stroke duration apparatus according to an exemplary embodiment of the present disclosure.

FIG. 9 and FIG. 10 are graphs showing the operation of the expansion stroke of a non-uniform stroke duration apparatus according to an exemplary embodiment of the present disclosure.

FIG. 11 is a graph comparing the heat release rate of an engine disposed with a non-uniform stroke duration apparatus according to an exemplary embodiment with the heat release rate of a conventional engine.

FIG. 12 is a graph comparing the work of an engine disposed with a non-uniform stroke duration apparatus according to an exemplary embodiment and the work of a conventional engine.

<Description of symbols>

| | |
|---|---|
| 10: crankshaft | 12: first main crankshaft |
| 14: second main crankshaft | 16: shaft hole |
| 18: crank web | 20: crank pin |
| 21, 22, 23, 24: first-fourth crank pin | |
| 30: pin journal unit | |
| 40: first pin journal portion | 41: first eccentric unit |
| 42: first internal bracket | 43: first external bracket |
| 46: large diameter part | 60: second pin journal part |
| 61: second eccentric unit | 62: second internal bracket |
| 63: second external bracket | 71: third eccentric unit |
| 72: third internal bracket | 73: third external bracket |
| 80, 81: first, second journal shaft | 90: third pin journal part |
| 91: fourth eccentric unit | 92: fourth internal bracket |
| 93: fourth external bracket | 96: large diameter part |
| 100: eccentric rotation transmitter | 110: internal bracket |
| 120, 121: power transmitter | 122: crankshaft pin |
| 123: crankshaft pin head | 124: rotation transmitting pin |
| 125: rotation transmitting pin head | |
| 126-129: first-fourth power transmitter | |
| 132: journal shaft pin | 133: journal shaft pin head |
| 134: rotation transmitting pin | 135: rotation transmitting pin |
| | head |
| 140: external bracket | 270: shaft pin head hole |
| 280: rotation transmitting pin head hole | |
| 290: large diameter portion slot | |
| 390: head slot | |

The drawings referenced above are not necessarily to scale, but should be understood as presenting rather simplified representations of various exemplary features illustrating the basic principles of the present disclosure. For example, certain design features of the present disclosure, including particular dimensions, direction, position, and shape, will be determined in part by the particular intended application and usage environment.

### DETAILED DESCRIPTION

Exemplary embodiments of the present disclosure will be described more fully hereafter with reference to the accompanying drawings, in which embodiments of the present disclosure are shown. As those skilled in the art would realize, the described embodiments may be modified in various different ways, all without departing from the spirit or scope of the present disclosure.

In order to clearly explain an exemplary embodiment of the present disclosure, parts irrelevant to the description are omitted, and the same reference numerals are used for identical or similar components throughout the specification.

The size and thickness of each component shown in the drawing are arbitrarily shown for better understanding and ease of description, and the present disclosure is not necessarily limited to what is shown in the drawing, and the thickness is shown by enlarging it to clearly express various parts and regions.

The terminology used herein is for describing various exemplary embodiments only and is not intended to limit the present disclosure. As used herein, the singular forms are intended to include the plural forms as well, unless the context clearly indicates otherwise.

Also, in the detailed description below, the names of the components are distinguished as first, second, etc. to distinguish them as they have the same relationship, and the description below is not necessarily limited to that order.

Throughout the specification, when a part is said to include a component, this does not mean that it excludes other components, but rather that it may include other components, unless otherwise specifically stated.

Additionally, terms such as “means”, “part”, “unit”, etc., described in the specification mean a comprehensive unit that performs at least one function or operation.

When we say that a part, such as a layer, membrane, region, or plate, is “on top of” another part, this includes not only cases where it is directly on top of the other part, but also cases where there are other parts in between.

In contrast, when an element is referred to as being “directly on” another element, there are no intervening elements present.

The terms “vehicle,” “car,” “vehicular,” “automobile,” or other similar terms used herein include automobiles, including passenger cars, including sports utility vehicles (SUVs), buses, trucks, and various commercial vehicles, ships, including various types of boats and vessels, aircraft, and the like, and include hybrid vehicles, electric vehicles, plug-in hybrid electric vehicles, hydrogen fuel vehicles, and other alternative fuel (e.g., fuels derived from sources other than petroleum) vehicles.

In a typical engine, the rotation speed (rpm) at each stroke remains almost constant. That is, with a time reference, the absolute combustion speed increases with engine rpm, but since the piston speed also increases, the relative combustion speed with a crank angle reference does not change much.

If the crankshaft speed is constant but the instantaneous revolutions per minute (rpm) of each stroke can be changed, the engine's fuel efficiency can be enhanced by use of the combust characteristics.

An exemplary embodiment will hereinafter be described in detail with reference to the accompanying drawings.

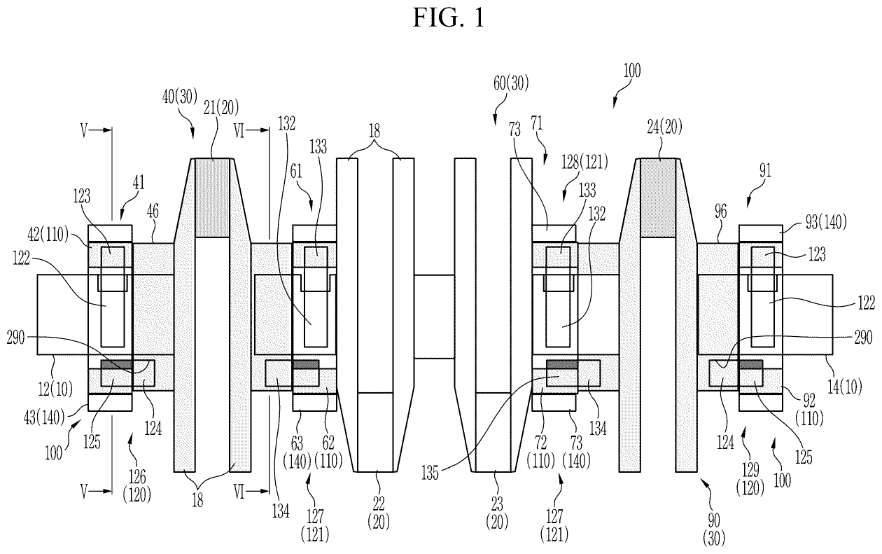

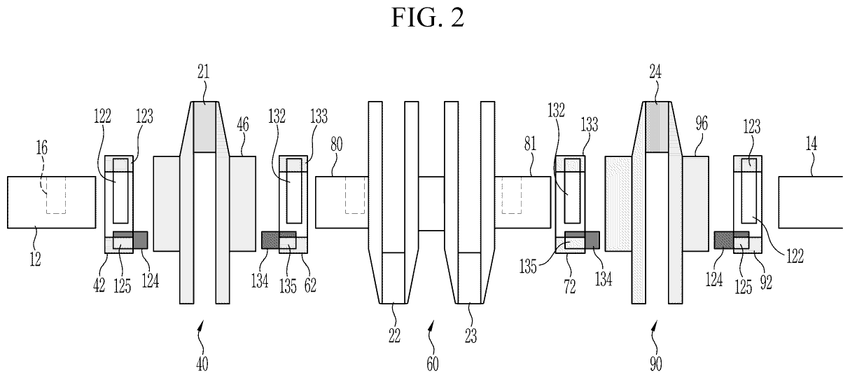

FIG. 1 is a cross-sectional view of a non-uniform stroke duration apparatus by an exemplary embodiment of the present disclosure, and FIG. 2 is an exploded sectional view of a non-uniform stroke duration apparatus according to an exemplary embodiment of the present disclosure.

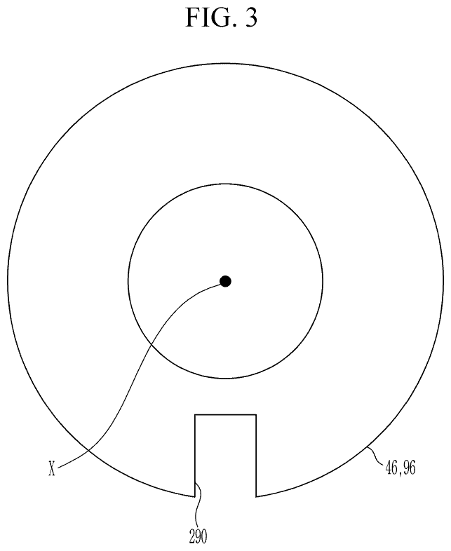

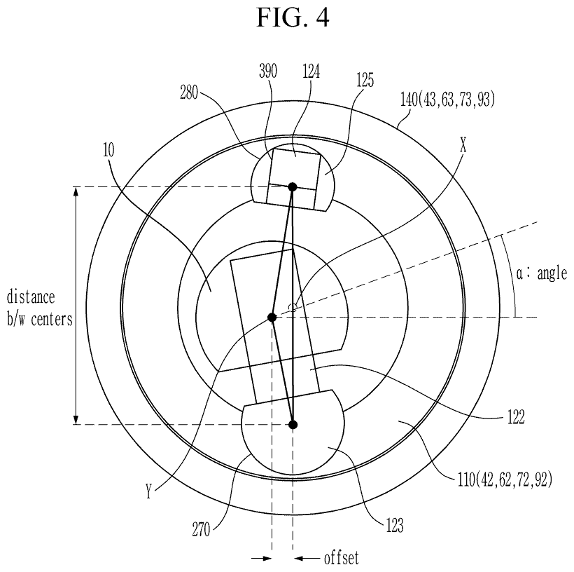

FIG. 3 is a cross-sectional view along line III-III of FIG. 1, and FIG. 4 is a cross-sectional view along line VI-VI of FIG. 1.

A non-uniform stroke duration apparatus according to an exemplary embodiment of the present disclosure is a configuration that can improve the fuel efficiency of an engine by varying the relative speed of the piston in each stroke.

Referring to FIG. 1, FIG. 2, FIG. 3 and FIG. 4, a non-uniform stroke duration apparatus (or variable stroke duration (VSD) apparatus) according to various exemplary embodiments of the present disclosure may include a crankshaft 10 including a first main crankshaft 12 and a second main crankshaft 14 coaxially disposed with the first main crankshaft 12 and constantly rotating at the same speed as the first main crankshaft 12, and including a predetermined crankshaft rotation center X, a plurality of pin journal units 30 disposed between the first main crankshaft 12 and the second main crankshaft 14, and an eccentric rotation transmitter 100 including an internal bracket 110 that rotates around an eccentric axis Y formed by a pivot angle α in a predetermined direction and spaced apart from the crankshaft rotation center X by a predetermined eccentric distance Δ, and changing a relative rotation speed of the pin journal units 30 with respect to the crankshaft 10.

The crankshaft 10 may include the first main crankshaft 12 on the left side of the drawing and the second main crankshaft 14 on the right side of the drawing, and the first main crankshaft 12 and the second main crankshaft 14 may rotate in the same phase, i.e., always at the same speed.

For example, the first main crankshaft 12 may be engaged with a timing chain, and the second main crankshaft 14 may be connected to a flywheel, transmission or drive motor.

The pin journal unit 30 may include a large diameter portion (46 or 96) supported by a crank bearing, not shown, and the pin journal unit 30 may be disposed coaxially with the crankshaft 10.

A crank pin 20 or crank pin journal is placed between a crank web (or counter weight) 18, on which a connecting rod is disposed, and converts reciprocal motion of a piston into rotation motion.

In a typical engine, a piston connected to a crankshaft through a crank pin is synchronized with the rotation motion of the crankshaft and performs reciprocal motion at a constant speed.

In a non-uniform stroke duration apparatus according to an exemplary embodiment of the present disclosure, the eccentric rotation transmitter 100 is configured to change the instantaneous motion speed of the piston by changing the relative rotation phase of the pin journal unit 30 with respect to the crankshaft 10.

The eccentric rotation transmitter 100 may include a power transmitter 120 that transmits torque between the crankshaft 10 and the internal bracket 110, and an external bracket 140 on which the internal bracket 110 is rotatably disposed.

The power transmitter 120 may include a crankshaft pin 122 that is movably inserted in a direction perpendicular to a longitudinal direction of the crankshaft 10, a crankshaft pin head 123 that is connected to the crankshaft pin 122 and rotatably disposed on the internal bracket 110, and a rotation transmitting pin 124 that is disposed between the internal bracket 110 and the pin journal unit 30 to transmit rotation.

The power transmitter 120 may further include a rotation transmitting pin head 125 which is rotatably inserted into the internal bracket 110 and into which the rotation transmitting pin 124 is inserted.

The internal bracket 110 may be disposed with a shaft pin head hole 270 into which the crankshaft pin head 123 is rotatably inserted and a rotation transmitting pin head hole 280 into which the rotation transmitting pin head 125 is rotatably inserted.

A large diameter portion slot 290 may be disposed in which the rotation transmitting pin 124 is inserted in the large diameter portion 46 and 96 of the pin journal unit 30.

A shaft hole 16 into which the crankshaft pin 122 is inserted is disposed in the crankshaft 10, and the crankshaft pin head 123 can rotate within the shaft pin head hole 270.

A head slot 390 is disposed in the rotation transmitting pin head 125, into which the rotation transmitting pin 124 is inserted, and the rotation transmitting pin 124 is inserted into the large diameter portion slot 290 to transmit rotation between the internal bracket 110, the crankshaft 10, and the pin journal unit 30. The rotation transmitting pin 124 may be disposed parallel to the longitudinal direction of the crankshaft 10.

As shown in FIG. 4, the distance between the crankshaft pin head 123 and the rotation transmitting pin head 125 is not changed, but the rotation center position Y of the pin journal unit 30 with respect to the center X of the crankshaft 10 is set to be spaced apart. The crankshaft pin 122, to which the crankshaft pin head 123 is connected, can move in a direction perpendicular to the longitudinal direction of the crankshaft 10, so that the internal bracket 110 can be rotated even if the rotation center position Y of the pin journal unit 30 with respect to the center X of the crankshaft 10 is set eccentrically.

The rotation center position Y of the pin journal unit 30 relative to the center X of the crankshaft 10 is offset, so that the relative rotation speed of the internal bracket 110 changes. That is, when the crankshaft 10 rotates 1 time, the internal bracket 110 forms a section where the relative rotation speed increases and decreases. This means that the internal bracket 110 can rotate with instantaneous speed increasing/deceleration.

Alternatively, a power transmitter 121 applicable to a non-uniform stroke duration apparatus according to various exemplary embodiments of the present disclosure may include a journal shaft pin 132 movably inserted in a direction perpendicular to a longitudinal direction of an axis of the pin journal units 30, a journal shaft pin head 133 connected to the journal shaft pin 132 and rotatably disposed on the internal bracket 110, and a rotation transmitting pin 134 disposed between the internal bracket 110 and the pin journal unit 30 to transmit rotation.

Additionally, the power transmitter 121 may further include a rotation transmitting pin head 135, which is rotatably inserted into the internal bracket 110 and into which the rotation transmitting pin 134 is inserted.

Since the power transmitter 121 operates in the same manner as the power transmitter 120 on both sides of the drawing described above, a detailed description is omitted.

The engine according to various exemplary embodiments of the present disclosure may be a variety of engines to which the non-uniform stroke duration apparatus according to an exemplary embodiment described above can be applied.

Additionally, the engine according to various exemplary embodiments of the present disclosure may be an engine including four cylinders. For the convenience of understanding, the engine according to an exemplary embodiment of the present disclosure is referred to as an engine including four cylinders with reference to the drawing.

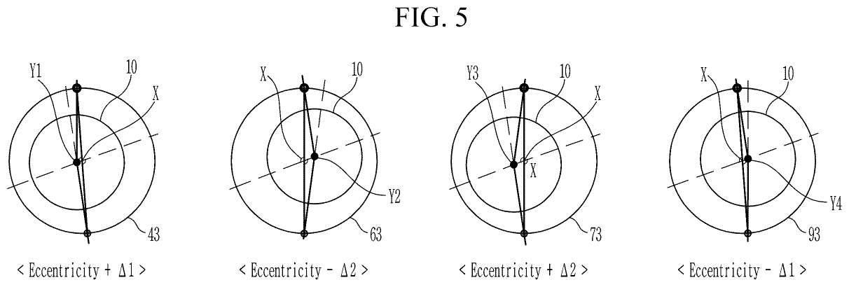

FIG. 5 is a drawing showing a rotation center of a crankshaft and an internal bracket of a non-uniform stroke duration apparatus according to an exemplary embodiment of the present disclosure.

Referring to FIG. 1 to FIG. 5, an engine according to various exemplary embodiments of the present disclosure may include the crankshaft 10 including the first main crankshaft 12 and the second main crankshaft 14 coaxially disposed with the first main crankshaft 12 and constantly rotating at the same speed as the first main crankshaft 12 and having the predetermined crankshaft rotation center X, a first pin journal portion 40 including a first crank pin 21 and a large diameter portion 46 protruding in the crankshaft 10 direction, a second pin journal portion 60 including a second crank pin 22, a third crank pin 23 and first and second journal shafts 80, and 81 protruding in both directions in the crankshaft 10 direction, and a third pin journal portion 90 including a fourth crank pin 24 and a large diameter portion 96 protruding in the crankshaft 10 direction.

The first crank pin 21, the second crank pin 22, the third crank pin 23, and the fourth crank pin 24 are connected to the corresponding cylinders, and the average rotation speed is the same as the crankshaft 10, and the instantaneous speed can be changed.

The engine according to various exemplary embodiments of the present disclosure may include a first eccentric unit 41 disposed between the first main crankshaft 12 and the first pin journal portion 40, including a first internal bracket 42 that rotates around a first eccentric axis Y1 formed by a pivot angle in a predetermined first direction and is spaced apart from the crankshaft rotation center X by a predetermined first eccentric distance, and changing a relative rotation speed of the first pin journal portion 40 with respect to the crankshaft 10.

Additionally, the engine according to an exemplary embodiment of the present disclosure includes a second eccentric unit 61 disposed between the first pin journal portion 40 and the second pin journal portion 60, including a second internal bracket 62 that rotates around a second eccentric axis Y2 disposed by a pivot angle in a predetermined second direction and is spaced apart from the crankshaft rotation center X by a predetermined second eccentric distance, and changing a relative rotation speed of the second pin journal portion 60 with respect to the first pin journal portion 40.

Additionally, the engine according to an exemplary embodiment of the present disclosure includes a third eccentric unit 71 disposed between the second pin journal portion 60 and the third pin journal portion 90, including a third internal bracket 72 that rotates around a third eccentric axis Y3 formed by a pivot angle in the predetermined first direction and is spaced apart from the crankshaft rotation center X by the predetermined second eccentric distance, and changing a relative rotation speed of the third pin journal portion 90 with respect to the second pin journal portion 60.

Additionally, the engine according to an exemplary embodiment of the present disclosure includes a fourth eccentric unit 91 disposed between the third pin journal portion 90 and the second main crankshaft 14, including a third internal bracket 72 that rotates around a fourth eccentric axis Y4 formed by a pivot angle in the predetermined second direction and is spaced apart from the crankshaft rotation center X by the predetermined first eccentric distance, and changing a relative rotation speed of the second main crankshaft 14 with respect to the third pin journal portion 90.

The first eccentric unit 41 may include a first power transmitter 126 for transmitting torque between the crankshaft 10 and the first internal bracket 42 and a first external bracket 43 on which the first internal bracket 42 is rotatably disposed.

The fourth eccentric unit 91 may include a fourth power transmitter 129 for transmitting torque between the crankshaft 10 and the fourth internal bracket 92, and a fourth external bracket 93 on which the fourth internal bracket 92 is rotatably disposed.

The first power transmitter 126 may include a crankshaft pin 122 movably inserted in a direction perpendicular to a longitudinal direction of the crankshaft 10, a crankshaft pin head 123 connected to the crankshaft pin 122 and rotatably disposed on the first internal bracket 42, and a rotation transmitting pin 124 disposed between the first internal bracket 42 and the first pin journal portion 40 to transmit rotation.

The fourth power transmitter 129 may include a crankshaft pin 122 movably inserted in a direction perpendicular to a longitudinal direction of the crankshaft 10, a crankshaft pin head 123 connected to the crankshaft pin 122 and rotatably disposed on the fourth internal bracket 92, and a rotation transmitting pin 124 disposed between the fourth internal bracket 92 and the third pin journal portion 90 to transmit rotation.

The first and fourth power transmitters 126, and 129 may further include a rotation transmitting pin head 125, which is rotatably inserted into the first and fourth internal brackets 42, and 92, and into which the rotation transmitting pin 124 is inserted.

The second eccentric unit 61 may include a second power transmitter 127 for transmitting torque between the first journal shaft 80 and the second internal bracket 62, and a second external bracket 63 on which the second internal bracket 62 is rotatably disposed.

The third eccentric unit 71 may include a third power transmitter 128 for transmitting torque between the second journal shaft 81 and the third internal bracket 72, and a third external bracket 73 on which the third internal bracket 72 is rotatably disposed.

The second power transmitter 127 may include a journal shaft pin 132 that is movably inserted in a direction perpendicular to a longitudinal direction of the first journal shaft 80, a journal shaft pin head 133 connected to the journal shaft pin 132 and rotatably disposed on the second internal bracket 62, and a rotation transmitting pin 134 that is disposed between the second internal bracket 62 and the second pin journal portion 60 to transmit rotation.

The third power transmitter 128 may include a journal shaft pin 132 that is movably inserted in a direction perpendicular to a longitudinal direction of the second journal shaft 81, a journal shaft pin head 133 connected to the journal shaft pin 132 and rotatably disposed on the third internal bracket 72, and a rotation transmitting pin 134 that is disposed between the third internal bracket 72 and the second pin journal portion 60 to transmit rotation.

The second and third power transmitters 127, and 128 may further include a rotation transmitting pin head 135, into which the rotation transmitting pin 134 is inserted, rotatably inserted into the second and third internal brackets 62, and 72, respectively.

The second eccentric distance may be twice the first eccentric distance.

As shown, FIG. 4 and in FIG. 5, within the first, fourth external brackets 43, and 93, the first and fourth internal brackets 42, and 92 are rotatably disposed respectively, and within the second, third external brackets 63, and 73, the second and third internal brackets 62, and 72 are rotatably disposed respectively.

The rotation centers Y1 and Y4 of the first and fourth internal brackets 42, and 92 may be spaced a first eccentric distance Δ from the crankshaft rotation center X, and the rotation centers Y2 and Y3 of the second and third internal brackets 62, and 72 may be spaced a second eccentric distance 2Δ, which is twice the first eccentric distance Δ from the crankshaft rotation center X.

The first direction and the second direction may be set symmetrically around the crankshaft.

Accordingly, the eccentricities of the first main crankshaft 12 and the first pin journal portion 40, the first pin journal portion 40 and the second pin journal portion 60, the second pin journal portion 60 and the third pin journal portion 90, and the third pin journal portion 90 and the second main crankshaft 14 can be +1:−2: +2:−1.

That is, the mount directions of the first, third external brackets 43, and 73 and the mount directions of the second, fourth external brackets 63, and 93 are the same, respectively, and the eccentric mount distance of the second, third external bracket 63, and 73 can be twice the eccentric mount distance of the first, fourth external bracket 43, and 93.

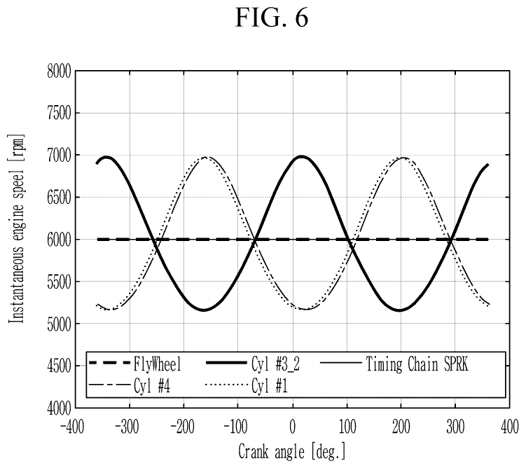

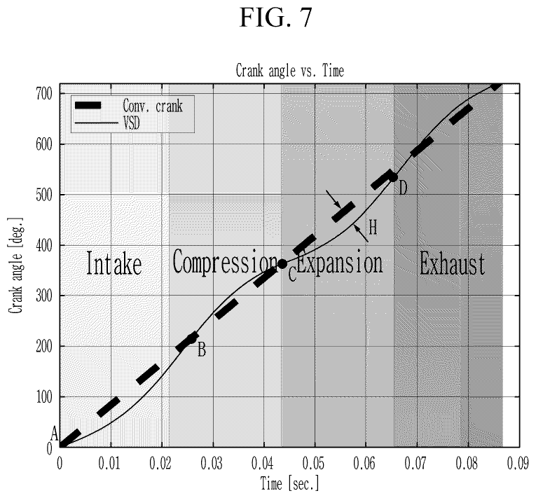

FIG. 6 and FIG. 7 are graphs showing the operation principle of a non-uniform stroke duration apparatus according to an exemplary embodiment of the present disclosure.

Referring to FIG. 6 and FIG. 7, in the non-uniform stroke duration apparatus according to an exemplary embodiment of the present disclosure, wherein when the eccentricity ratios between the first main crankshaft 12 and the first pin journal portion 40, the first pin journal portion 40 and the second pin journal portion 60, the second pin journal portion 60 and the third pin journal portion 90, and the third pin journal portion 90 and the second main crankshaft 14 are disposed to be +1:−2: +2:−1, the first crank pin 21 and the fourth crank pin 24 have the same instantaneous speed and the same phase, and the second crank pin 22 and the third crank pin 23 have the same instantaneous speed and the same phase by accumulation of the eccentricity ratios. The eccentricities of the first pin journal portion 40, the second pin journal portion 60, and the third pin journal portion 90 with respect to the crankshaft 10 due to the accumulation of the eccentricity ratios are +1; −1; +1, so that the first main crankshaft 12 and the second main crankshaft 14 always rotate at the same phase and speed.

For example, the timing chain and flywheel shown in the drawing may be connected to the first main crankshaft 12 and the second main crankshaft 14 respectively, and the first main crankshaft 12 and the second main crankshaft 14 may rotate at the same speed.

With the rotation of the crankshaft 10 as a reference, the instantaneous speeds of the first pin journal portion 40, the second pin journal portion 60, and the third pin journal portion 90 can be expressed as shown in FIG. 6. Here, assuming that the combustion order is first, third, fourth, second cylinder, the moving speed of the piston at a certain instant can be different, but the first, second, third, and fourth crank pins 21, 22, 23, and 24 within the intake, compression, expansion, and exhaust strokes can include the same instantaneous speed profile.

The direction (a) in which the rotation center of the internal bracket 110 is offset with respect to the rotation of the crankshaft 10 may determine the moments (A, B, C, D) at which the average rotation speed of the pin journal unit 30 and the instantaneous rotation speed of the pin journal unit 30 coincide.

Additionally, the offset size of the external bracket 140, i.e., the eccentric distance (Δ), determines the maximum speed difference (H) between the average rotation speed of the pin journal unit 30 and the instantaneous rotation speed of the pin journal unit 30.

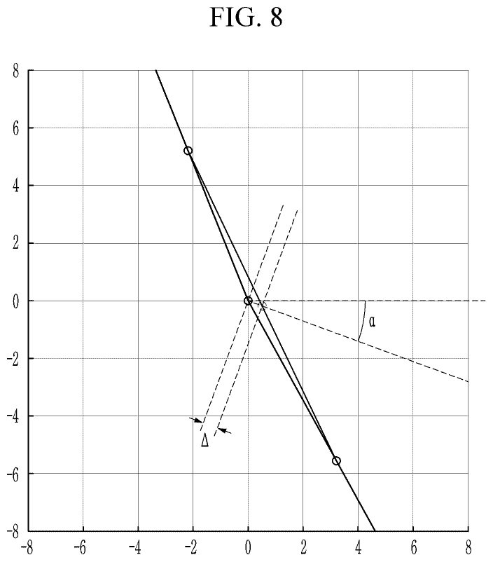

FIG. 8 is a graph illustrating the eccentricity and pivot angle of a non-uniform stroke duration apparatus according to an exemplary embodiment of the present disclosure.

Referring to FIG. 4, FIG. 7 and FIG. 8, the first eccentric distance (Δ) that the rotation centers Y1 and Y4 of the first and fourth internal brackets 42, and 92 are separated from the crankshaft rotation center X may determine the maximum speed difference (H) between the average rotation speed of the pin journal unit 30 and the instantaneous rotation speed of the pin journal unit 30.

The mount directions of the first, third external brackets 43, and 73 and the mount directions of the second, fourth external brackets 63, and 93 are set symmetrically with respect to the crankshaft 10.

As shown in FIG. 5, rotation centers Y1 and Y3 of the first, third internal brackets 42, and 72 may be spaced from the crankshaft rotation center X to the left of the drawing, and rotation centers Y2 and Y4 of the second, fourth internal brackets 62, and 92 may be spaced from the crankshaft rotation center X to the right of the drawing.

The pivot angle (α) of the predetermined direction can be defined as an angle eccentric with respect to the horizontal direction of, for example, the crankshaft 10.

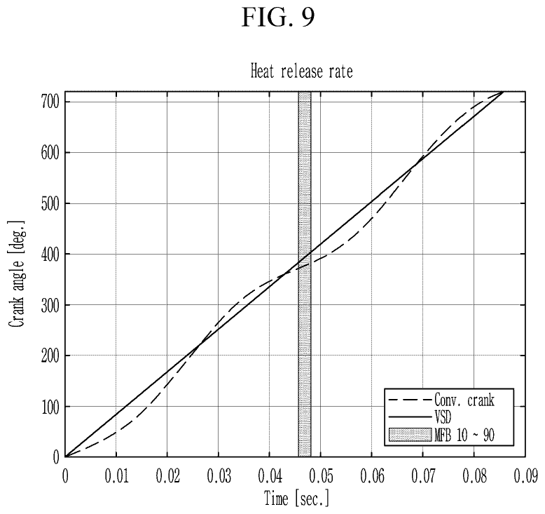

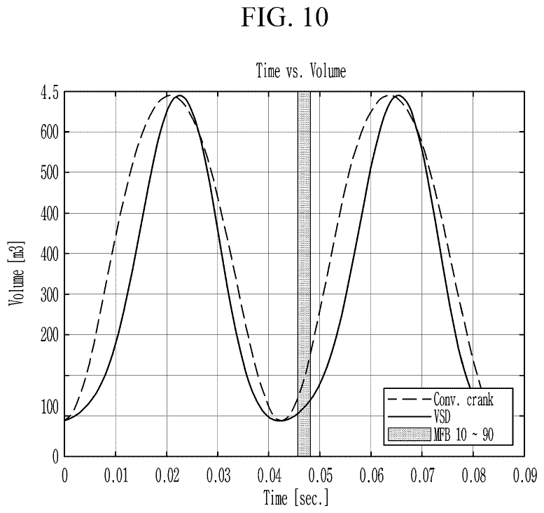

FIG. 9 and FIG. 10 are graphs showing the operation of the expansion stroke of a non-uniform stroke duration apparatus according to an exemplary embodiment of the present disclosure.

FIG. 9 shows the comparison of the typical crankshaft speed and the piston speed with the non-uniform stroke duration apparatus according to an exemplary embodiment over time, and FIG. 10 shows the typical engine combustion chamber volume and the engine combustion chamber volume with the non-uniform stroke duration apparatus according to an exemplary embodiment over time.

The marked portion of the drawing represents the combust mass fraction (MFB; mass fraction burned) in the range of 10 to 90, indicating the combustion period for comparison.

As shown in the drawing, the engine in which the non-uniform stroke duration apparatus according to an exemplary embodiment of the present disclosure is applied has a low relative descending speed of the piston, and the combustion chamber volume is relatively small during that period.

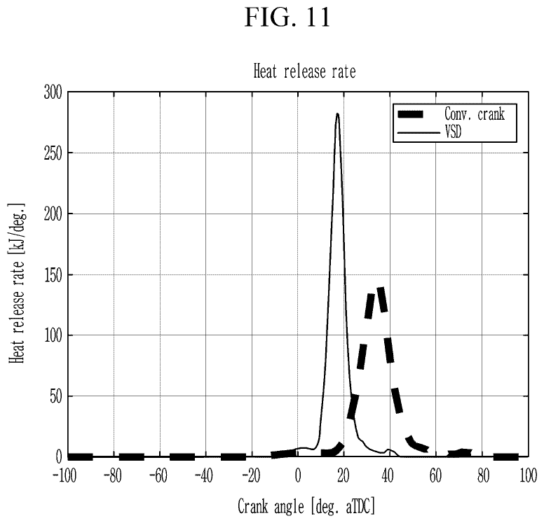

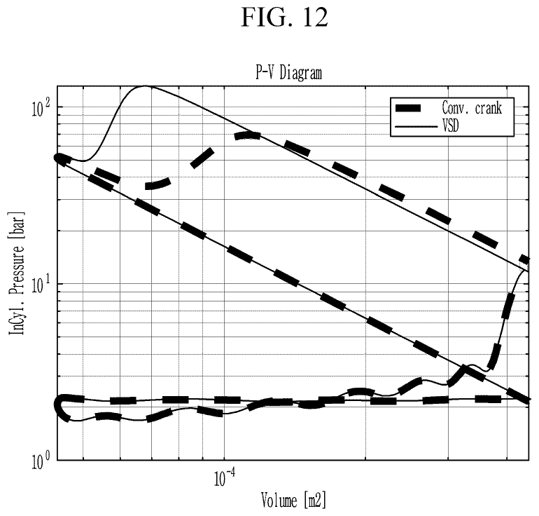

FIG. 11 is a graph comparing the heat release rate of an engine disposed with a non-uniform stroke duration apparatus according to an exemplary embodiment with the heat release rate of a conventional engine, and FIG. 12 is a graph comparing the work of an engine disposed with a non-uniform stroke duration apparatus according to an exemplary embodiment and the work of a conventional engine.

Referring to FIG. 9 to FIG. 12, when the instantaneous rotation speed of the pin journal unit 30 in the combust process is slowed downwards, the time required per crank angle increases, and the heat release rate per crank angle increases even though the heat release rate per time is the same.

Here, the pressure effect, which decreases relatively little due to slow expansion during the combustion period, was not considered.

The pressure is determined using the heat release rate and volume per unit crank angle, and the expansion work is determined using the pressure and volume as follows.

$$dQ / d θ = ( γ / γ - 1 ) P ( dV / d θ ) + ( γ / γ - 1 ) V ( dP / d θ )$$

Here, dQ/dθ is the heat release rate, y is the specific heat ratio, V is the volume, and P is the pressure.

The work can be determined using the above results.

$$Work = ∮ P d V$$

By controlling the piston speed of the explosion stroke of an engine disposed with the non-uniform stroke duration apparatus according to an exemplary embodiment of the present disclosure, the combustion chamber pressure, i.e., the indicated mean effective pressure (IMEP), can be increased.

Assuming that the IMEP of a typical engine is 21.2 bar, it was confirmed that the IMEP can be increased to 26.0 bar by controlling the piston instantaneous speed of the explosion stroke of an engine disposed with the non-uniform stroke duration apparatus according to an exemplary embodiment under the same conditions.

That is, as shown in the graph of FIG. 12, in an engine disposed with the non-uniform stroke duration apparatus according to an exemplary embodiment of the present disclosure, the combustion chamber pressure, i.e., the indicated average effective pressure (IMEP), can be increased by controlling the piston instantaneous speed of the expansion stroke, and it can be confirmed that work is increased through this.

An engine, referring to FIG. 7 and FIG. 8, disposed with the non-uniform stroke duration apparatus according to an exemplary embodiment of the present disclosure, has a pivot angle (α) set so that the relative speed of the piston with respect to the crankshaft 10 in the expansion stroke of each cylinder is slowed down, thereby improving the fuel consumption.

As described above, according to an exemplary embodiment of the non-uniform stroke duration apparatus and an engine including the same, the fuel efficiency of the engine can be improved by controlling the relative instantaneous speed of the piston in each stroke.

While the present disclosure has been described in connection with what is presently considered to be practical embodiments, it is to be understood that the present disclosure is not limited to the disclosed exemplary embodiments of the present disclosure. On the other hand, it is intended to cover various modifications and equivalent claims as well as various alternatives and modifications thereof. It is intended that the scope of the present disclosure be defined by the Claims appended hereto and their equivalents.

What is claimed is:

1. A non-uniform stroke duration apparatus comprising:
a crankshaft including a first main crankshaft and a second main crankshaft coaxially disposed with the first main crankshaft and constantly rotating at the same speed as the first main crankshaft, and having a predetermined crankshaft rotation center;
a plurality of pin journal units disposed between the first main crankshaft and the second main crankshaft; and
an eccentric rotation transmitter including an internal bracket that rotates around an eccentric axis formed by a pivot angle in a predetermined direction and spaced apart from the crankshaft rotation center by a predetermined eccentric distance, and changing a relative rotation speed of the pin journal units with respect to the crankshaft.

2. The non-uniform stroke duration apparatus of claim 1, wherein the eccentric rotation transmitter comprises:
a power transmitter that transmits torque between the crankshaft and the internal bracket; and
an external bracket on which the internal bracket is rotatably disposed.

3. The non-uniform stroke duration apparatus of claim 2, wherein the power transmitter comprises:
a crankshaft pin that is movably inserted in the crankshaft in a direction perpendicular to a longitudinal direction of the crankshaft;
a crankshaft pin head that is connected to the crankshaft pin and rotatably disposed on the internal bracket; and
a rotation transmitting pin that is disposed between the internal bracket and the pin journal unit to transmit rotation.

4. The non-uniform stroke duration apparatus of claim 3, wherein the power transmitter further comprises:
a rotation transmitting pin head which is rotatably inserted into the internal bracket and into which the rotation transmitting pin is inserted.

5. The non-uniform stroke duration apparatus of claim 2, wherein the power transmitter comprises:
a journal shaft pin movably inserted in a direction perpendicular to a longitudinal direction of an axis of the pin journal units;
a journal shaft pin head connected to the journal shaft pin and rotatably disposed on the internal bracket; and
a rotation transmitting pin disposed between the internal bracket and the pin journal unit to transmit rotation.

6. The non-uniform stroke duration apparatus of claim 5, wherein the power transmitter further comprises a rotation transmitting pin head which is rotatably inserted into the internal bracket and into which the rotation transmitting pin is inserted.

7. An engine comprising:
a crankshaft including a first main crankshaft and a second main crankshaft coaxially disposed with the first main crankshaft and constantly rotating at the same speed as the first main crankshaft and having a predetermined crankshaft rotation center;
a first pin journal portion including a first crank pin and a large diameter portion protruding in a crankshaft direction;
a second pin journal portion including a second crank pin, a third crank pin and first and second journal shafts protruding in both directions in the crankshaft direction;
a third pin journal portion including a fourth crank pin and a large diameter portion protruding in the crankshaft direction;
a first eccentric unit disposed between the first main crankshaft and the first pin journal portion, including a first internal bracket that rotates around a first eccentric axis formed by a pivot angle in a predetermined first direction and is spaced apart from the crankshaft rotation center by a predetermined first eccentric distance, and changing a relative rotation speed of the first pin journal portion with respect to the crankshaft;
a second eccentric unit disposed between the first pin journal portion and the second pin journal portion, including a second internal bracket that rotates around a second eccentric axis formed by a pivot angle in a predetermined second direction and is spaced apart from the crankshaft rotation center by a predetermined second eccentric distance, and changing a relative rotation speed of the second pin journal portion with respect to the first pin journal portion;
a third eccentric unit disposed between the second pin journal portion and the third pin journal portion, including a third internal bracket that rotates around a third eccentric axis formed by a pivot angle in the predetermined first direction and is spaced apart from the crankshaft rotation center by the predetermined second eccentric distance, and changing a relative rotation speed of the third pin journal portion with respect to the second pin journal portion; and
a fourth eccentric unit disposed between the third pin journal part and the second main crankshaft, including a third internal bracket that rotates around a fourth eccentric axis formed by a pivot angle in the predetermined second direction and is spaced apart from the crankshaft rotation center by the predetermined first eccentric distance, and changing a relative rotation speed of the second main crankshaft with respect to the third pin journal portion.

8. The engine of claim 7,
wherein the first eccentric unit comprises:
a first power transmitter for transmitting torque between the crankshaft and the first internal bracket; and
a first external bracket on which the first internal bracket is rotatably disposed, and
wherein the fourth eccentric unit includes:
a fourth power transmitter for transmitting torque between the crankshaft and the fourth internal bracket; and
a fourth external bracket on which the fourth internal bracket is rotatably disposed.

9. The engine of claim 8,
wherein the first power transmitter comprises;
a crankshaft pin movably inserted in a direction perpendicular to a longitudinal direction of the crankshaft;
a crankshaft pin head connected to the crankshaft pin and rotatably disposed on the first internal bracket; and
a rotation transmitting pin disposed between the first internal bracket and the first pin journal portion to transmit rotation, and
wherein the fourth power transmitter comprises:
a crankshaft pin movably inserted in a direction perpendicular to a longitudinal direction of the crankshaft;
a crankshaft pin head connected to the crankshaft pin and rotatably disposed on the fourth internal bracket; and
a rotation transmitting pin disposed between the fourth internal bracket and the third pin journal portion to transmit rotation.

10. The engine of claim 9, wherein the first and fourth power transmitters further comprise a rotation transmitting pin head, which is rotatably inserted into the first and fourth internal brackets and into which the rotation transmitting pin is inserted, respectively.

11. The engine of claim 8,
wherein the second eccentric unit comprises:
a second power transmitter for transmitting torque between the first journal shaft and the second internal bracket; and
a second external bracket on which the second internal bracket is rotatably disposed, and
wherein the third eccentric unit includes:
a third power transmitter for transmitting torque between the second journal shaft and the third internal bracket; and
a third external bracket on which the third internal bracket is rotatably disposed.

12. The engine of claim 11,
wherein the second power transmitter comprises:
a journal shaft pin that is movably inserted in a direction perpendicular to a longitudinal direction of the first journal shaft;
a journal shaft pin head connected to the journal shaft pin and rotatably disposed on the second internal bracket; and
a rotation transmitting pin that is disposed between the second internal bracket and the second pin journal portion to transmit rotation, and
wherein the third power transmitter comprises:
a journal shaft pin that is movably inserted in a direction perpendicular to a longitudinal direction of the second journal shaft;
a journal shaft pin head connected to the journal shaft pin and rotatably disposed on the third internal bracket; and
a rotation transmitting pin that is disposed between the third internal bracket and the second pin journal portion to transmit rotation.

13. The engine of claim 12, wherein the second and third power transmitters further comprise a rotation transmitting pin head, into which the rotation transmitting pin is inserted, rotatably inserted into the second and third internal brackets respectively.

14. The engine of claim 7,
wherein the second eccentric distance is twice the first eccentric distance, and
wherein the first direction and the second direction is set symmetrically around the crankshaft.

15. The engine of claim 14, wherein the first direction and the second direction are predetermined to slow down a relative speed of the piston to the crankshaft during the expansion stroke of each cylinder.
